(19) United States
(12) Patent Application Publication
(10) Pub. No.: US 2018/0311862 A1
(43) Pub. Date: Nov. 1, 2018

(54) METHOD FOR PRODUCING A DIFFUSING SHEET OF CORK, DIFFUSING CORK WALL, AND ISOTHERMIC CONTAINER COMPRISING SUCH A WALL

(71) Applicant: CORKPACK GROUP, Lasne (BE)

(72) Inventor: Alexandre NARINX, Waterloo (BE)

(73) Assignee: CORKPACK GROUP, Lasne (BE)

(21) Appl. No.: 15/771,216

(22) PCT Filed: Oct. 18, 2016
(86) PCT No.: PCT/EP2016/075000

§ 371 Date: Apr. 26, 2018

(30) Foreign Application Priority Data
Oct. 29, 2015 (BE) 2015/5702

(51) Int. Cl. B27J 5/00; B27M 1/02; B65D 81/38; F25D 3/06

(52) U.S. Cl. CPC B27J 5/00; B27M 1/02; F25D 2303/083; F25D 3/06; B65D 81/3818

(57) ABSTRACT

The invention relates to a method for producing a diffusing sheet of cork for an isothermic container, characterised in that a starting sheet of cork with an initial density is compressed so as to laterally increase the density, and to form hardened outer skins with a higher level of diffusion compared to the initial level, and thereby control the diffusion of the compressed sheet.

### FIELD OF THE INVENTION

The invention relates to an isothermic container for containing pharmaceutical products, food products, or any other type of items demanding to be transported at a directed temperature.

### PRIOR ART

Different isothermic containers are currently known. Isothermic containers enable to keep their content at a certain desired temperature, in order to preserve it at a directed temperature during their transportation or their storage.

Document US 2002/0050147 discloses an isothermic container comprising a double plastic wall inside which are placed heating or refrigerating elements. This double wall comprising heating or refrigerating elements defines a volume which is used as a container. The container will be kept at a certain temperature according to the content. Thanks to this type of container, items are not in direct contact with the heating or refrigerating elements.

In the container of the prior art, the inner walls of the double wall are made of plastic and are less insulative than the outer walls, such that the heat flow is transmitted towards the container, and not towards the outside. The problem is that the temperature of the refrigerating or heating elements is transmitted quickly to the container through the plastic walls, this could create a heat shock for the items contained. This heat shock is a problem for food, for example, for which the sudden change in temperature is not recommended. In addition, when refrigerating elements transmit their temperature to the container and heat up, a condensation is created and there is humidity on the plastic walls.

Document CH 147246 A itself discloses a thermally insulative container of which the walls are made using several cork layers, with air gaps between the cork layers. This container enables to insulate the content from the outside, but it does not contain any heating or refrigerating element.

### SUMMARY OF THE INVENTION

An aim of the invention is first to provide a method for producing a diffusing sheet for an isothermic container, enabling to avoid heat shocks by ensuring a staggered diffusion over time of the temperature through this sheet.

To this end, the invention relates to a method for producing a diffusing sheet of cork for an isothermic container. A starting sheet of cork with an initial density is compressed so as to laterally increase the density, and to form hardened outer skins with a higher level of diffusion compared to the initial level, and thereby control the diffusion of the compressed sheet.

Thanks to this method of the invention, a diffusing sheet of cork is obtained with the outer skins of a higher density thereof than the inner part, which gives a diffusing property to the outer surfaces and an insulative property to the inner part of the sheet. This sheet structure therefore enables to have a diffusing and insulating power at the same time, thanks to the diffusing power of the outer casing and to the insulating power of the inner honeycomb part. The result obtained is that the sheet thereby created offers a control of the diffusion of the temperature through it. In addition, the outer casing offers a rigidity to the sheet, which allows it a precise machining, and an assembly for it to be held in the container. This rigidity provided by the casing is essential, without which the sheets should be a lot thicker and the useful volume of the container would be highly decreased.

On the other hand, the invention relates to a diffusing sheet of cork to an isothermic container produced according to the production method of the invention.

The invention moreover proposes a type of isothermic container comprising walls, said walls comprising an outer sheet of cork and an inner sheet of cork, with an interstitial space arranged to receive a heat source, the walls being arranged to receive a content, characterised in that said inner sheet is a diffusing sheet of cork produced according to said production method.

The inner sheet of the wall is the diffusing sheet of the invention, compressed so as to have a specific structure having an increased density of the outer surfaces thereof. This inner wall thereby improved enables to diffuse, over time, the temperature of the heat source towards the volume able to receive a content which must be kept at a certain temperature. The heat source can, of course, be a cold or hot source. According to the thickness of the sublayers in the inner sheet and the densities of these sublayers, the diffusion of the temperature is done more or less quickly. This results in being able to manage the diffusion time, according, for example, to the transportation time of the content having to be kept under a controlled temperature. The temperature is controlled thanks to this diffusing sheet. On the other hand, the outer sheet has a lower density than the inner sheet, in order to make the heat flow be directed towards the volume provided to receive the content, and not towards the outside of the container. The difference in density between the outer sheet and the inner sheet coupled to the multi-density system of the inner sheet enables to optimise the effect wanted.

Another advantage is thereby that the heat shocks experienced by the containers of the prior art are avoided. The temperature will diffuse slowly through this inner sheet, in order to not suddenly change the temperature of the volume provided to receive the content. The distribution of the cold or of the hot is controlled in advance thanks to the thickness of the compressed cork sublayers of the inner sheet.

Another advancement observed is that cork is a material that absorbs humidity. When the cold heat source heats up and condenses, the condensation will be absorbed by the outer sheet. Indeed, the outer sheet is less dense than the inner sheet, which favours the absorption of humidity by this outer sheet. In addition, the dense casing of the inner wall also favours this absorption of humidity by this outer sheet, as this casing acts as a barrier to humidity.

On the other hand, the central part of the inner sheet of the wall enables to store cold or hot, which must travel through two outer casings. The inner sheet will therefore be loaded in order to itself become a hot or cold reserve. Therefore, hot or cold can be kept in a more stable way if the container is open for brief handling.

Also, the inner sheet being loaded uniformly over the height and the width thereof is thereby assimilated to the element enabling a perfectly homogenous diffusion of the desired temperature and not at a specific source.

These three claimed means of the invention proceed with one same inventive concept, closely connected to the diffusing sheet, as such, and the production method thereof.

### BRIEF DESCRIPTION OF THE FIGURES

These aspects, as well as other aspects of the invention will be clarified by the detailed description of the invention, reference being made to the appended drawings, whereon:

FIG. 1 is a cross-section view of the diffusing sheet of compressed cork of the invention;

FIG. 2 is a top view of the isothermic container of the invention; And FIG. 3 is a perspective view of the container in FIG. 2.

The figures are not drawn to scale. Similar elements are recorded by similar references on the figures.

### DETAILED DESCRIPTION OF SPECIFIC EMBODIMENTS

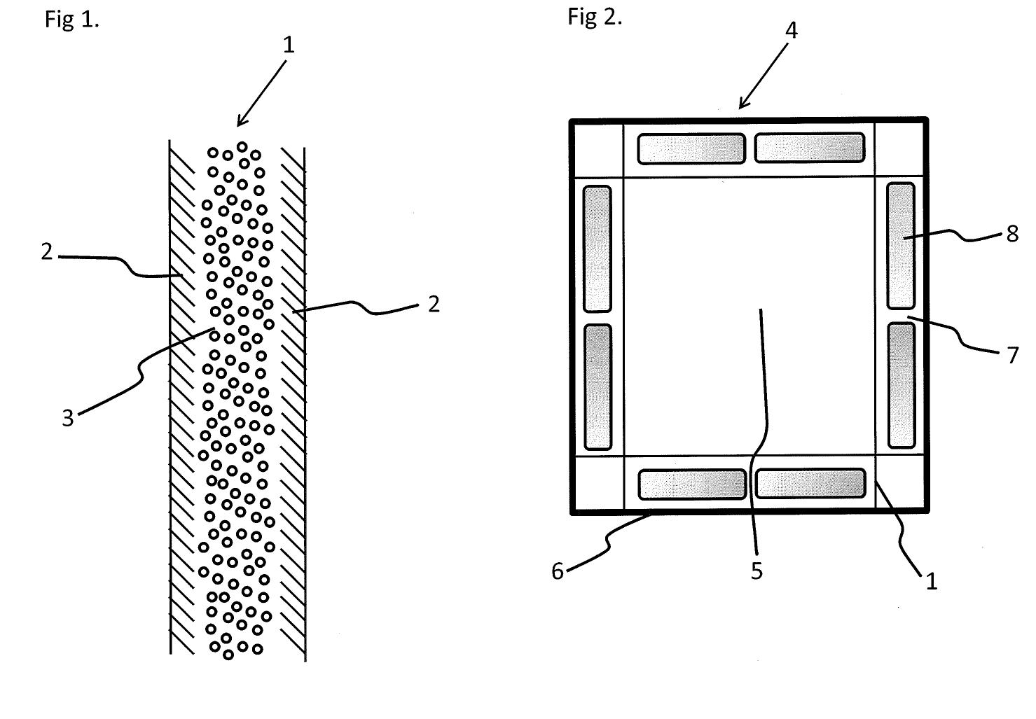

In reference to FIG. 1, a starting sheet of cork has been compressed on the surface up to a determined thickness, and so as to have a varying density on the section of the sheet 1. The density within said sheet 1 is higher on the outer surfaces 2 than in the inner part 3 of said sheet 1 to enable a control of the diffusion of the temperature through said sheet.

During this production method, said starting sheet of cork here is compressed over the whole of the surface thereof.

The outer surfaces 2 are assimilated to dense casings, having a density situated between 0.6 to 0.85, while the inner part 3 of the diffusing wall 1 has a honeycomb structure with a density of between 0.15 and 0.45. The inner honeycomb part 3 now has a higher insulative power than the outer casings 2. This structure of sheet 1 enables to have a diffusing and insulative power at the same time, thanks to the diffusing power of the outer casings 2 and to the insulative power of the inner honeycomb part 3.

A determined proportion between the thicknesses of the dense outer casings 2 and the inner honeycomb part 3 must be obtained. This is the same for the ratio between the densities of these two parts. The proportion of the inner honeycomb part 3 must not be increased too much, at the risk that the sheet 1 is too insulative and that the diffusion of temperature through it is done too slowly. On the contrary, the proportion of outer casings 2 must not be increased too much either, at the risk that the sheet 1 is not insulative enough and that the diffusion of temperature through it is made too quickly.

The dense outer casings 2 also give an adequate rigidity to the sheet in order to give it the support thereof in the container 4. To reach an ideal insulation, the sheet of cork 1 must have a low density. The problem which occurs, is that the sheet 1 is thereby too flexible and is not supported correctly. Two solutions can be considered. A first solution would be to increase the thickness of the sheet 1, which would decrease the useful volume of the container 4, which is a crucial element to optimise in the field of transportation. The second solution would be to increase the density of the sheet 1 such that it supports itself, but the insulation would be decreased and there would be a risk of heat shock. In order to reach one same insulation with a sufficient density to support the sheet 1, the thickness of this sheet 1 must be increased and from then, the useful volume of the container 4 must be decreased.

To preserve an adequate insulation with a wall thickness as low as possible, a person skilled in the art would, on the other hand, be led to think to use a sheet of low density cork but reinforced by another rigid material. They would not think about compressing the cork wall in order to give it more rigid outer surfaces 2 to keep the inner part 3 insulative.

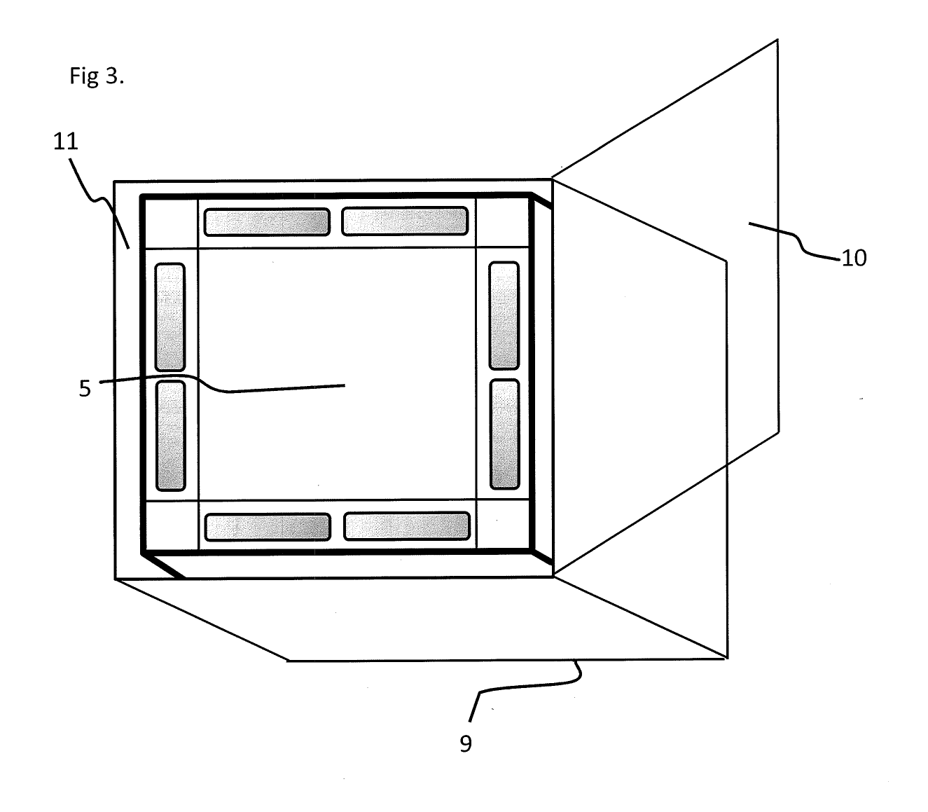

The isothermic container 4 in FIG. 2 seen from above, uses inner diffusing sheets 1 of compressed cork. In concrete terms, the isothermic container 4 comprises walls around a volume 5 able to receive the content to hold at a certain temperature. The container 4 is characterised in that each wall comprises an outer sheet of cork 6, a space 7 which could contain, and here containing, at least one heat source 8 and one inner sheet 1 produced by compressing cork. Said inner sheet 1 separates the heat source 8 from the content located in the volume 5. In addition, said inner sheet 1 has a higher density of the outer surfaces 2 than the density of the inner part 3 thereof in order to diffuse the temperature as desired. The geometry of the inner sheet 1 will use the transmission speed of the temperature of the heat sources 8 towards the volume 5 able to receive the content which must be kept at a certain temperature. Indeed, according to the thickness of the sublayers 2 and 3 in the inner sheet 1 and the densities of these sublayers 2 and 3, the diffusion of the temperature is done more or less quickly. This enables to manage the diffusion time, according, for example, to the transportation time of the content having to be kept under a controlled temperature.

In addition, the outer sheet 6 has a lower density than the inner sheet 1 in order to make the heat flow be directed towards the volume 5, and not towards the outside of the container 4.

As a heat source, ice packs, containers of a hot liquid, etc. can be considered.

In certain cases, the isothermic container 4, of which the walls form a primary isothermic space 5, can be put into an outer packaging with a secondary space 11 for separation and protection from the primary isothermic space 5. Indeed, the container is, in certain cases, placed in a packaging, which enables it to have a cover 10 and a bottom 9. This packaging, which can be made of cardboard, for example, is practical for transportation.

Packaging is a means for separation and protection. But in most cases, the container itself already comprises a bottom and a cover. Packaging thereby only adds an additional cover 10 and an additional bottom 9 to the container 4.

The space 7 can contain a heat source, but, in certain cases, this can be done without. Indeed, the container of the invention can be used simply by using the fact that the outer walls, during transportation or storage, let the outside temperature pass through little by little, the outer walls regulate the passage of this temperature.

According to a preferred embodiment of the invention, the isothermic container 4 has the shape of a parallelepiped rectangle.

1. Method for producing a diffusing sheet of cork for an isothermic container, comprising a starting sheet of cork with an initial density is compressed so as to laterally increase the density, and to form hardened outer skins with a higher level of diffusion compared to the initial level, and thereby control the diffusion of the compressed sheet.

2. Method for producing a diffusing sheet of cork for an isothermic container according to claim 1, said starting sheet of cork being compressed over the whole of the surface thereof.

3. Diffusing sheet of cork for an isothermic container, produced according to the production method of claim 1.

4. Isothermic container comprising walls, said walls comprising an outer sheet of cork and an inner sheet of cork, with an interstitial space arranged to receive a heat source, the walls being arranged to receive a content comprising said inner sheet is a sheet according to claim 3.

5. Isothermic container according to claim 4, said inner sheet having a higher density than said outer wall.

6. Isothermic container according to claim 4, wherein said walls form a primary isothermic space 5 closed by a bottom and a cover of a packaging with a secondary space for receiving said walls.

7. Isothermic container according to claim 4, which has the shape of a parallelepiped rectangle.
